(19) United States
(12) Patent Application Publication
(10) Pub. No.: US 2014/0236478 A1
(43) Pub. Date: Aug. 21, 2014

(54) METHOD AND SYSTEM THAT OPEN DATA, FILES AND APPLICATIONS AUTOMATICALLY BASED ON GEOGRAPHIC LOCATION

(71) Applicant: Yakov Z. Mermelstein, Spring Valley, NY (US)

(72) Inventor: Yakov Z. Mermelstein, Spring Valley, NY (US)

(21) Appl. No.: 13/772,785

(22) Filed: Feb. 21, 2013

(51) Int. Cl. G06F 17/30; G01C 21/36

(52) U.S. Cl. CPC G06F 17/30241; G01C 21/3679
USPC 701/454; 707/781; 726/27; 705/32; 705/39

(57) ABSTRACT

In its simplest, basic form, the invention involves personal electronic devices that automatically open data, files and applications, based on geographic location. The device for automatically using data, files and/or applications includes means for continuously automatically precisely locating the exact global physical location of the device; and, means for identifying each data, file and/or application having a specific global physical location corresponding to a current exact global physical location of the device and for then using said data or file and/or initiating said application. In a preferred embodiment, there is also a means for tagging each data, file and application at the time of creation and/or editing to identify a specific global physical location.

### FIELD OF THE INVENTION

This invention relates to the electronics and communications industry and, more particularly, to a method and system which can automatically open data, files and applications, based on geographic location.

### BACKGROUND OF THE INVENTION

Personal electronic devices, such as inter alia, smart phones, PDAs, and Ipads, have become ubiquitous. They have become invaluable to people for conducting their affairs. People are literally lost without them.

An all too common problem is that people get to a location and then cannot find the file/data they need. For example, a business traveler comes to an automobile rental agency and needs the confirmation number. He has to hunt through all his emails to find the one from the automobile rental company with the confirmation number. This can take several minutes and maybe he just does not find it, since he looked in the wrong folder or the email was misfiled. This same problem can occur at a hotel.

A traveler may find an out of the way restaurant he has never visited, but he did see a review which he saved and now wants to retrieve it and read it before entering. The problem is where did he put it. He cannot locate it, but he knows he has it somewhere—but where?

Technology already exists for instantaneously determining the exact geographic physical location of a device.

The Global Positioning System (GPS) is a space-based satellite navigation system that provides location and time information in all weather conditions, anywhere on or near the Earth where there is an unobstructed line of sight to four or more GPS satellites.

A GPS receiver calculates its position by precisely timing the signals sent by GPS satellites high above the Earth. Each satellite continually transmits messages that include the time the message was transmitted and the satellite position at time of message transmission. The receiver uses the messages it receives to determine the transit time of each message and computes the distance to each satellite using the speed of light. Each of these distances and the satellites' locations define a sphere. The receiver is on the surface of each of these spheres when the distances and the satellites' locations are correct. These distances and satellites' locations are used to compute the location of the receiver using the navigation equations. This location is then displayed, perhaps with a moving map display or latitude and longitude; elevation information may be included. Many GPS units show derived information such as direction and speed, calculated from position changes.

In general, GPS receivers are composed of an antenna, tuned to the frequencies transmitted by the satellites, receiver-processors, and a highly stable clock (often a crystal oscillator). They may also include a display for providing location and speed information to the user. A receiver is often described by its number of channels: this signifies how many satellites it can monitor simultaneously. Originally limited to four or five, this has progressively increased over the years so that, as of 2007, receivers typically have between 12 and 20 channels.

GPS satellites circle the earth twice a day in a very precise orbit and transmit signal information to earth. GPS receivers take this information and use triangulation to calculate the user's exact location. Essentially, the GPS receiver compares the time a signal was transmitted by a satellite with the time it was received. The time difference tells the GPS receiver how far away the satellite is. With distance measurements from a several satellites, the receiver can determine the user's position. Many GPS devices can display it on the unit's screen or even on an electronic map.

A GPS receiver must be locked on to the signal of at least three satellites to calculate a 2D position (latitude and longitude) and track movement. With four or more satellites in view, the receiver can determine the user's 3D position (latitude, longitude and altitude). Once the user's position has been determined, the GPS unit can calculate other information, such as speed, bearing, track, trip distance, distance to destination, sunrise and sunset time and more.

Today's GPS receivers are extremely accurate, thanks to their parallel multi-channel design. Garmin® claims its newer GPS receivers are accurate to less than three meters on average and Magellan® also claims an accuracy of 3 meters for its most sophisticated unit.

Huang (U.S. Pat. No. 8,316,046) discloses a journaling subsystem on a mobile device that stores event data related to applications or other subsystems running on the mobile device. The event data can be stored and indexed in a journal database so that a timeline of past events can be reconstructed in response to search queries. In some implementations, a timeline can be reconstructed with markers on a map display based on search results. When the user interacts with a marker on the map display, the event data collected by the mobile device is made available to the user.

Modern mobile devices, such as smart phones, IPads®, tablets, etc, include a myriad of applications. A visit to an App store, such as the Apple® Store, will reveal literally hundreds of applications that can run on that personal mobile device. Some examples of applications include: hotel reservations and check-in, restaurant reservations and ordering, car rentals, health club membership. A typical user may use one or more of these applications many times a day. These applications can capture, generate and receive information, which can then be stored or communicated to other devices.

Also stored in these mobile devices are many hundreds, if not thousands, of data, files and emails that contain valuable information that must be recalled and used from time to time.

The problem with these “modern” devices is accessing the relevant applications and data and files. All the user can do is to search for it, but that takes time. It also presupposes the information was correctly filed so he can find it in a search.

These modern mobile devices need some combination of a search feature keyed to the location, based on the GPS. This way the user can immediately access the information that is relevant for the place where he is currently located.

Therefore, there is a need in the industry for personal electronic devices which are capable of opening data, emails, files and applications automatically, based on geographic location.

### SUMMARY OF THE INVENTION

These and other objects of the invention are achieved with the use of personal electronic devices which can open data, files and applications automatically, based on geographic location.

According to the Invention, a mobile device includes a GPS chip which constantly determines the exact physical location of the device. That location is continually passed to a search module, which is continuously searching the tagged location of each email, data, file and application in the device or in the user's designated Internet site or the user's designated Internet cloud site. At any given moment, the mobile device can automatically call up on the screen the email, data, file or application that has a location tag for the physical location where the device currently is located.

Other objects, features and advantages of the present invention will become apparent upon reading the following detailed description in conjunction with the drawings and the claims.

### BRIEF DESCRIPTION OF THE DRAWINGS

For a better understanding of the invention, its operation and specific objects attained by its uses, reference should be had to accompanying drawings and descriptive matter in which there are illustrated preferred embodiments of the invention

The invention will now be described in connection with certain preferred embodiments with reference to the following illustrative figures so that it may be more fully understood.

FIG. 1 is a flow chart, showing location tagging of a file or application

FIG. 2 is a flow chart, showing the search process for a file or application with the location tag for the current location.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

According to the Invention, in its simplest, basic form, personal electronic devices automatically open data, files and applications, based on geographic location.

The device for automatically using files and/or application includes Means for continuously automatically precisely locating the global physical location of the device; and, Means for identifying each data, file and/or application having a specific global physical location corresponding to a current global physical location of said device and for then using said data or file and/or initiating said application. In a preferred embodiment, there is also Means for tagging each data, file and application at the time of creation and/or editing to identify a specific global physical location.

By using is meant that the data or files are opened and the applications are initiated or launched.

Stated succinctly, the Invention may be defined as a method of opening data or files and or activating applications, comprising the steps of: determining the geographic global position of a user; identifying data, files and applications for that user that include a location tag corresponding to the geographic global position of the user; and using said data, files and applications corresponding to said geographic global position of the user. In a preferred embodiment, it would also include creating the location tag for each data, file and application at the time of creation and/or editing to identify a specific global physical location.

For purposes of this Invention, the term personal electronic devices covers all portable electronic devices that a user may easily carry with him and which provide him with access to his data, files and information and also have some connection to the Internet. Such devices include, inter alia, mobile devices, cell phones, smart phones, hand held computers, laptop computers, palm top computers, personal digital assistant (PDA), electronic pads and tablets.

Further, it may be appreciated that users no longer store data, files and application on just their personal electronic device. Often they also store such data, files and applications on a designated Internet site or even in an Internet cloud. Cloud technology is now becoming especially common and popular.

Cloud computing is the use of computing resources (hardware and software) that are delivered as a service over a network (typically the Internet). The name comes from the use of a cloud-shaped symbol as an abstraction for the complex infrastructure it contains in system diagrams. Cloud computing entrusts remote services with a user's data, software and computation.

The personal electronic device, according to the Invention, includes some type of a global position system (GPS), which will continually identify the physical location of the device. According to the Invention herein, the device may automatically open data, files and application at the physical location of the device. More typically, the device would be programmed to open data, files and applications within a predefined distance of the physical location of the device. This is because there is always some error factor of a meter or two in determining location. Besides, sometimes the user may be in a big location and he wants the device to call up all data, files and applications within a certain range of where he is standing.

In particular, the term Global Positioning System should also include any communication system that helps the device determine its location, and it is not limited to and may include “WIFI,” “Bluetooth,” “NFC” and/or “GPS.”

By means of an Application Programming Interface (API), Applications can be identified and then activated. In particular, the mobile device continuously knows the geographic location, based on its internal GPS chip. The geographic location information is directed to the API. It then continuously scans each Application to identify and activate any Application that has a location tag matching the current location of the mobile device.

When each Application is loaded into the mobile device (or Internet site or designated cloud), a location tag is specified for it. Technology already exists to search files and/or applications to find ones with a particular location.

In particular, Microsoft sells a program called Outlook® which has extensive market penetration. Most people either use this program or something very similar. Outlook (as well as other competitive programs) has a calendar function which allows you to record appointments and meetings, including location. This is just one type of location tag that can be utilized for searching according to the herein invention.

According to the Invention for each data, file or email that a user wants to be able to locate quickly when he reaches a specified location, when that data, email or file is created or edited, a location tag is included. This is known technology, and is already used by Outlook, as aforementioned.

By means of a File Search Module, data, emails and other files can be identified and then used/opened/activated. In particular, the mobile device continuously knows the geographic location, based on its internal GPS chip. The location information is directed to the File Search Module. It then continuously scans each data, email and files to identify and activate any data, email or file that has a location tag matching the current location of the mobile device.

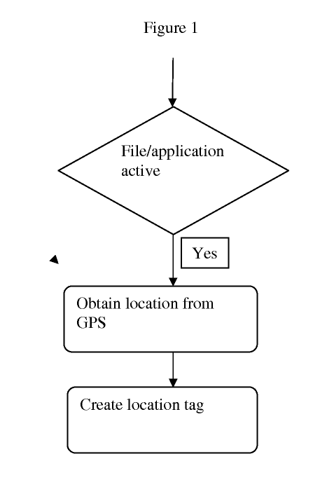

FIG. 1 is a flow diagram of an exemplary process for tagging files and applications with a location tag. The process is initiated whenever a new file or application is created and saved on the personal mobile device (or Internet site or designated cloud). Internally the GPS chip generates the current physical location information and that information is inserted in the location tag of the subject file or application. This is also done whenever the file or application is edited. These location tags can then be used just as keywords are used in any search query.

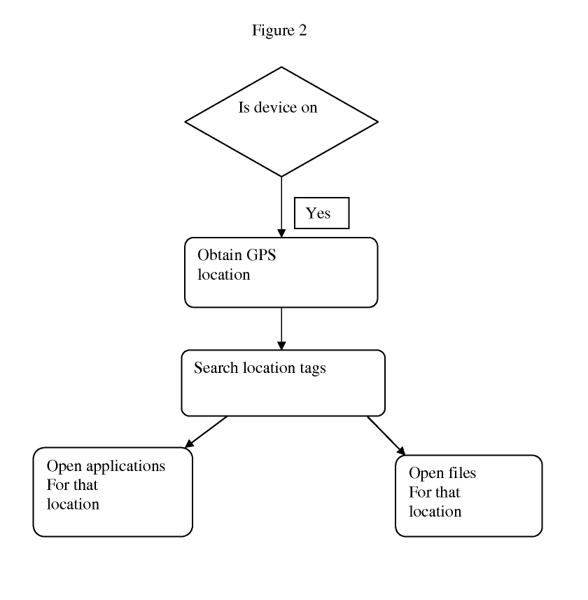

FIG. 2 is a flow diagram of an exemplary process for searching files and applications. The internal GPS chip generates the current physical location and then a search query is created for this physical location. Then, the location tags of all of the files and applications are searched to see which ones have this physical location. Search results can be generated and made available on the screen of the mobile device. The files are automatically opened and the applications are automatically initiated.

Among the available uses of the herein subject Invention is that the term files includes emails, and the device automatically opens emails having a specific global physical location corresponding to a current global physical location of the device. Another possibility is that the term files includes files including calendar events and/or to do tasks, and wherein said device automatically opens calendar events and/or to do tasks having a specific global physical location corresponding to a current global physical location of the device.

It may also be understand that word processing and/or Excel® files and also databases may also be searched to identify documents, records and/or files having a location tag corresponding to the current global physical location of the device.

In many situations the device may be used to good advantage to automatically open Applications that are pertinent to the current location of the device.

The term ‘files’ includes restaurant menus, and the device automatically opens restaurant menus having a specific global physical location corresponding to a current global physical location of the device.

The phrase Ordering list is used herein to include not just restaurant menus, but any list of available items for purchase/rental. A person may go to a supermarket, for example, and see a list of products which he may then order. In a video store a list of available movies may be utilized by the purchaser.

There may also be applications, such as an ordering procedure (for a restaurant, supermarket, book store, mass merchandize merchant, video store, etc), and wherein the device automatically initiates a ordering procedure for a business having a specific global physical location corresponding to a current global physical location of the device. The ordering procedure may even include the location from which the ordering procedure is initiated (such as a table, or kiosk, or counter), so the items that were ordered can be delivered to the user quickly and efficiently.

For example, when you come to a restaurant, the device will activate the application and it will also optionally locate the table at which you are sitting. It will show all today's menus and orders can be placed with a prepaid system so you will not have to wait until the waiter brings you the bill. At the end of the meal when you leave the restaurant, the digital key used to communicate with the restaurant will become void and will not work anymore, until the device detects that you have come again to that restaurant.

Another useful application is check-in procedures (such as at a hotel, club, restaurant etc) and the device automatically initiates a check in procedure for a business having a specific global physical location corresponding to a current global physical location of the device. If desired, the check in procedure includes downloading to the device an electronic key for a facility (such as a hotel room, a health club locker etc) corresponding to the check in procedure.

The check in procedure may establish a specific time during which said electronic key may be used. For example, the user may be able to use the item for only an hour, a day, or a week. This would be useful for car rentals, which typically are for only specified times. Computers and other electronic devices may also be used for rented for specified times. Health club memberships may time out after a fixed time.

It may also include a location of an item for which said ordering procedure is initiated. This would be helpful for car rentals, where the user needs to know where the rented care is located.

The security code of an item for which said ordering procedure is initiated may also be indicated. In the case of a car rental, this code may be needed to start the car. It could also be used to start a computer (or other electronic device) which is being rented.

When you reach the hotel, the device will open up the email/file/application with your hotel reservation. If desired, there can be a check-in on your device. It can send an electronic room key to your device to unlock the room via wireless communication by transmitting the key to the door. This can protect the user to ensure that no one steals the key. The key combination will work only when the system detects you in the area. It is also possible share the key digitally with another person, like a spouse or child.

In a similar manner, the same can be done with the user's home door to unlock it wirelessly with a digital key with a confirmation of the location of the device.

You can also generate temporary keys to grant rights to someone else. This can even be a defined set time. For example, the person can use the electronic key for an hour and, after that, it times out and cannot be used. It is also possible to send a notification to the administrator each time the door is opened. You can even design it so that you can open the doors at home and/or in the hotel remotely.

Still another possible application is a rental car check in procedure, and the device automatically initiates a rental car check in procedure for a rental car location having a specific global physical location corresponding to a current global physical location of the device. The rental car check in procedure may include the location of a car for which the ordering procedure is initiated. It may also include a security code of the car for which the ordering procedure is initiated.

As was true with restaurants and hotels, the same can be done with cars. You will be able to control a car from the application. When you start the car remotely, it will only be started but cannot be driven. It is only when the device detects that the user is in the car, then the car may be activated to be driven. This feature can be used by rental companies so that, when you reserve a car you, will receive the digital remote key to the rented car, which can work in this same manner. Further, it can be timed to work only for the duration of the rental. When you arrive at the location of the renting company, it will automatically open up the application file with the exact car information and location, and even the parking bay information, so you can easily find it and then use the digital key to drive the car.

Another unique application may be to limit operation of a device.

A security system can be implemented with the device, and may include: Means for identifying a global physical location of said device; Means for continuously automatically precisely locating the exact global physical location of a user for said device; and Means for permitting operation of said device only when user is within a predefined distance from said global physical location of said device. It may also work to permit use only when the user is at the global physical location of the device. For example, this feature may be used as a security system for computers or motor vehicles.

Whereas there are systems to tell car operators how far they can drive before they need a gas refill, these systems do not identify the exact locations of the filling station. Therefore, another useful application can implement this concept. There can be a system for operating a motor vehicle, including: Means for identifying global physical locations of gasoline filling stations; Means for continuously automatically precisely locating the global physical location of said motor vehicle; Means for determining how many miles the motor vehicle can travel at the current rate of speed before it runs out of gas; and Means for identifying global physical locations of gasoline filling stations that are along a route of said motor vehicle and which can be reached before said motor vehicle runs out of gas

The herein Invention may also be used for employee check-in/out instead of a time clock, and also to determine in what geographic areas they were during their work hours. There can be a system for automatically determining the time of work of an employee, including” Means for identifying a global physical work location of an employee; Means for continuously automatically precisely locating the exact global physical location of said employee; and Means for determining when said employee is within said global physical work location of said employee. Optionally, it may include means for recording when said employee is within the global physical work location of the employee.

In other words, this system may be used for employment check-in. It will bring up the application to do an online check in when you arrive at work and it is confirmed by the location of the device. The employee might be checked in automatically when he is confirmed by the location of the device, and checked out in the same manner when he leaves).

The system could also generate a new digital key to your device (such as your smart phone) each time you check in to work, so you can use it wirelessly to open doors and unlock your office computer and other secure equipment. The computer and other office equipment will lock automatically when you move away more then a certain predefined distance. The key in general will reset and will require a new key when the location of the device detects you leaving the building or work.

Another application can be an on line secure payment system, such as NFC or PayPal or other electronic Internet based payment protocols. The chip in the device will only get updated with relevant information and as well as the ability to communicate with the merchant, when the location of the device matches the store location. When the device (e.g. smart phone) comes within the vicinity of the store, a new pay key will be generated and will be sent to your device and also to the store at that location. After you finish shopping and when you leave the area, it will be voided, so no one can use it again. When you reach a second store, the process is repeated for this store at the new location.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

I claim:

1. A device for automatically using data, files and applications, comprising:
Means for continuously automatically precisely locating the exact global physical location of the device; and
Means for identifying each data, file and application having a specific global physical location corresponding to a current global physical location of said device and for then using said data, file and/or application.

2. A device according to claim 1, further comprising Means for tagging each data, file and application at the time of creation and/or editing to identify a specific global physical location.

3. A device according to claim 1, wherein said Means for identifying identifies each data, file and application having a specific global physical location within a predefined distance of said current global physical location of said device.

4. A device according to claim 1, wherein said data, files and applications are stored in a personal mobile device, or a designated Internet site or a designated cloud.

5. A device according to claim 1, wherein said Means for continuously automatically precisely locating the exact global physical location of the device comprises a global position system (GPS).

6. A device according to claim 1, wherein said device is selected from the group comprising: mobile devices, cell phones, smart phones, hand held computers, laptop computers, palm top computers, personal digital assistant (PDA), electronic pads and tablets.

7. A device according to claim 1, wherein said files including emails, and wherein said device automatically opens emails having a specific global physical location corresponding to a current global physical location of said device.

8. A device according to claim 1, wherein said files including calendar events, and wherein said device automatically opens calendar events having a specific global physical location corresponding to a current global physical location of said device.

9. A device according to claim 1, wherein said files including to do tasks, and wherein said device automatically opens to do tasks having a specific global physical location corresponding to a current global physical location of said device.

10. A device according to claim 1, wherein said files including ordering lists, and wherein said device automatically opens ordering lists having a specific global physical location corresponding to a current global physical location of said device.

11. A device according to claim 1, wherein said files including membership information, and wherein said device automatically opens membership information having a specific global physical location corresponding to a current global physical location of said device.

12. A device according to claim 1, wherein said application including a check in procedure, and wherein said device automatically initiating a check in procedure for a business having a specific global physical location corresponding to a current global physical location of said device.

13. A device according to claim 12, wherein said check in procedure includes downloading to said device an electronic key for a facility corresponding to said check in procedure.

14. A device according to claim 13, wherein said check in procedure establishes a specific time during which said electronic key may be used.

15. A device according to claim 13, wherein said check in procedure includes a location of an item for which said ordering procedure is initiated.

16. A device according to claim 13, wherein said check in procedure includes a security code of an item for which said ordering procedure is initiated.

17. A device according to claim 1, wherein said applications including an ordering procedure, and wherein said device automatically initiating an ordering procedure for a business having a specific global physical location corresponding to a current global physical location of said device.

18. A device according to claim 17, wherein said ordering procedure includes a location from which said ordering procedure is initiated.

19. A device according to claim 17, wherein said ordering procedure includes generating a list of items available for purchase at that time from said business.

20. A method of opening files and or activating applications, comprising the steps of:
A. Determining the geographic global position of a user;
B. Identifying data, files and applications for said user that include a location tag corresponding to said geographic global position of said user; and
C. Using said data, files and applications corresponding to said geographic global position of said user.

21. A method according to claim 20, further comprising creating said location tag for each data, file and application at a time of creation and/or editing to identify a specific global physical location.

22. A method according to claim 25, wherein said data, files and applications being stored in a mobile personal device, or a designated Internet site or a designated cloud.

23. A system for automatically determining time of work of an employee:
Means for identifying a global physical work location of an employee;
Means for continuously automatically precisely locating the exact global physical location of said employee; and
Means for determining when said employee is within said global physical work location of said employee.

24. A system according to claim 23, further comprising means for recording when said employee is within said global physical work location of said employee.

25. A security system for a device, comprising:
Means for identifying a global physical location of said device;
Means for continuously automatically precisely locating the exact global physical location of a user for said device; and
Means for permitting operation of said device only when user is within a predefined distance from said global physical location of said device.

26. A security system according to claim 25, wherein said Means for permitting allowing operation of said device only when user is at said global physical location of said device.

27. A security system according to claim 25, wherein said device is selected from the group comprising: a computer, a motor vehicle, electronic devices, facilities.

28. A system for operating a motor vehicle, comprising:
Means for identifying global physical locations of gasoline filling stations;
Means for continuously automatically precisely locating the global physical location of said motor vehicle;
Means for determining how many miles the motor vehicle can travel at the current rate of speed before it runs out of gas; and
Means for identifying global physical locations of gasoline filling stations that are along a route of said motor vehicle and which can be reached before said motor vehicle runs out of gas.

29. A system for secured electronic payment over the Internet comprising:
A. Means for identifying global physical location of a designated business;
B. Means for continuously automatically precisely locating the global physical location of mobile device of a user;
C. Means for determining if said mobile device of said user is currently located at said global physical location of a designated business;
D. If said mobile device of said user is currently located at said global physical location of a designated business, establishing a payment communication link between said designated business and said user.

30. A system for payment according to claim 29, further comprising disabling said payment communication link when said user leaves said designated business.
